(19) United States
(12) Patent Application Publication
(10) Pub. No.: US 2006/0053009 A1
(43) Pub. Date: Mar. 9, 2006

(54) Distributed speech recognition system and method

(76) Inventors: Myeong-Gi Jeong, Suwon-si (KR); Myeon-Kee Youn, Incheon-si (KR); Hyun-Sik Shim, Yongin-si (KR)

Correspondence Address: Robert E. Bushnell, Suite 300, 1522 K Street, N.W., Washington, DC, 20005-1202, US

(21) Appl. No.: 11/200,203

(22) Filed: Aug. 10, 2005

(30) Foreign Application Priority Data
Sep. 6, 2004 (KR) 2004-70956

(51) Int. Cl. G10L 15/20

(52) U.S. Cl. 704/234

(57) ABSTRACT

A distributed speech recognition system and method thereof in accordance with the present invention enables a word and a natural language to be recognized using detection of a pause period in a speech period in an inputted speech signal, and various groups of recognition vocabulary (for example, a home speech recognition vocabulary, a telematics vocabulary for a vehicle, a vocabulary for call center, and so forth) to be processed in the same speech recognition system by determining the recognition vocabulary required by a corresponding terminal using an identifier of the terminal since various terminals require various speech recognition targets. In addition, various types of channel distortion occurring due to the type of terminal and the recognition environment are minimized by adapting them to a speech database model using a channel estimation method so that the speech recognition performance is enhanced.

### CLAIM OF PRIORITY

This application makes reference to, incorporates the same herein, and claims all benefits accruing under 35 U.S.C. §119 from an application for DISTRIBUTED SPEECH RECOGNITION SYSTEM AND METHOD earlier filed in the Korean Intellectual Feature Office on Sep. 6, 2004 and there duly assigned Serial No. 2004-70956.

### BACKGROUND OF THE INVENTION

1. Technical Field

The present invention relates to a distributed speech recognition system and method using wireless communication between a network server and a mobile terminal. More particularly, the present invention relates to a distributed speech recognition system and method capable of recognizing a natural language, as well as countless words of vocabulary, in a mobile terminal by receiving help from a network server connected to a mobile communication network. The natural language is recognized as a result of processing in the mobile terminal, which utilizes language information in the network server in order to enable the mobile terminal, which is restricted in calculation capability and use of memory, to accomplish effective speech recognition.

2. Related Art

Generally, speech recognition technology may be classified into two types: speech recognition and speaker recognition. Speech recognition systems are, in turn, divided into speaker-dependent systems for recognition of only a specified speaker and speaker-independent systems for recognition of unspecified speakers or all speakers. The speaker-dependent system stores and registers the speech of a user before performing recognition, and compares a pattern of inputted speech with that of the stored speech in order to perform speech recognition.

On the other hand, the speech-independent system recognizes the speech of unspecified speakers without requiring the user to register his/her own speech before operation, as required in the speech-dependent system. Specifically, the speech-independent system collects the speech of the unspecified speakers in order to study a statistical model, and performs speech recognition using the studied statistical model. Accordingly, individual characteristics of each speaker are eliminated, while common features between the respective speakers are highlighted.

Compared to the speaker independent system, the speaker-dependent system has a relatively high rate of speech recognition and easy technical realization. Thus, it is more advantageous to put the speaker dependent system into practical use

Generally, large-sized system of a stand-alone type and small-sized systems employed in terminals have been mainly used as speech recognition systems.

Currently, with the advent of the distributed speech recognition system, systems having various structures have been developed and have appeared in the marketplace. Many distributed speech recognition systems have a server/client structure through use of a network, wherein the client carries out a pretreatment process for extracting a speech signal feature needed in the speech recognition or removing noise, and the server has an actual recognition engine to perform the recognition, or both the client and the server simultaneously perform recognition. Such existing distributed speech recognition systems place the focus on how to overcome the limited resources owned by the client.

For example, since the hardware restriction of a mobile terminal such as a hand phone, a telematics terminal, or a mobile WLAN (wireless local area network) terminal, imposes a limitation on speech recognition performance, resources of the server connected to the wired or wireless communication network have to or should be utilized in order to overcome the limitation of the mobile terminal.

Accordingly, a high performance speech recognition system required by the client is built into the network server to be utilized. That is, a word recognition system of the scope required by the mobile terminal is constructed. In the speech recognition system constructed in this manner in the network server, a speech recognition target vocabulary is determined based on the main purpose for which the terminal uses speech recognition, and a user uses a speech recognition system which operates individually on the hand phone, the intelligent mobile terminal, the telematics terminal, etc., and which is capable of performing distributed speech recognition depending on the main purpose of the mobile terminal.

Constructed distributed speech recognition systems are not yet capable of performing word recognition associated with the feature of the mobile terminal together with the narrative natural language recognition, and a standard capable of performing such recognition also has not yet been suggested.

### SUMMARY OF THE INVENTION

It is, therefore, an object of the present invention to provide a distributed speech recognition system and method capable of performing unrestricted word recognition and natural language speech recognition based on construction of a recognition system that is responsive to channel change caused by a speech recognition environment on a speech data period, and on whether there is a short pause period within the speech data period.

It is another objective to provide a distributed speech recognition system capable of enhancing the efficiency of the recognition system by selecting a database of a recognition target required by each terminal, and by improving recognition performance by extracting channel information and adapting a recognition target model to a channel feature in order to reduce the influence that the environment to be recognized causes on the recognition.

According to an aspect of the present invention, a distributed speech recognition system comprises: a first speech recognition unit for checking a pause period of a speech period in an inputted speech signal to determine the type of inputted speech for selecting a recognition target model of stored speech on the basis of the kind of determined speech when the inputted speech can be recognized by itself so as to thus recognize data of the inputted speech on the basis of the selected recognition target model, and for transmitting speech recognition request data through a network when the inputted speech cannot be recognized by itself; and a second speech recognition unit for analyzing speech recognition request data transmitted from the first speech recognition unit through the network so as to select the recognition target model corresponding to the speech to be recognized, for applying the selected speech recognition target model to perform language processing through speech recognition, and for transmitting the resultant language processing data to the first speech recognition unit through the network.

Preferably, the first speech recognition unit is mounted on the terminal, and the second speech recognition unit is mounted on a network server, so that the speech recognition process is performed in a distributed scheme.

Preferably, the terminal is at least one of a telemetics terminal, a mobile terminal, a WALN, and an IP terminal.

Preferably, the network is a wired network or a wireless network.

Preferably, the first speech recognition unit includes: a speech detection unit for detecting a speech period from the inputted speech signal; a pause detection unit for detecting the pause period in the speech period detected by the speech detection unit so as to determine the kind of inputted speech signal; a channel estimation unit for estimating channel characteristics using data of a non-speech period other than the speech period detected in the speech detection unit; a feature extraction unit for extracting a recognition feature of the speech data when the pause period is not detected by the pause detection unit; a data processing unit for generating speech recognition request data and for transmitting same to the second speech recognition unit of the server when the pause period is detected by the pause detection unit; and a speech recognition unit for removing the noise component by adapting the channel component estimated by the channel estimation unit to the recognition target acoustic model stored in the database, and for performing noise recognition.

Preferably, the speech detection unit detects the speech period according to the result of a comparison of a zero-crossing rate and energy of a speech waveform for the input speech signal and a preset threshold value.

Preferably, the speech recognition unit includes: a model adaptation unit for removing the noise component by adapting the channel component estimated in the channel estimation unit to the recognition target acoustic model stored in the database; and a speech recognition unit for decoding the speech data processed in the model adaptation unit and performing speech recognition of the inputted speech signal.

Preferably, the pause detection unit determines the inputted speech data to be speech data for the words when the pause period does not exist in the speech period detected in the speech detection unit, and determines the inputted speech data to be speech data for the natural language (sentences or vocabulary) when the pause period exists in the speech period.

Preferably, the channel estimation uses a calculating method comprising at least one of a frequency analysis of continuous short periods, an energy distribution, a cepstrum, and a wave waveform average in a time domain.

Preferably, the data processing unit includes: a transmission data construction unit for constructing the speech recognition processing request data used to transmit the pause period to a second speech recognition unit when the pause period is detected in the pause detection unit; and a data transmission unit for transmitting the constructed speech recognition processing request data to the second speech recognition system of the server through the network.

Preferably, the speech recognition processing request data includes at least one of a speech recognition flag, a terminal identifier, a channel estimation flag, a recognition ID, an entire data size, a speech data size, a channel data size, speech data, and channel data.

Preferably, the second speech recognition unit includes: a data reception unit for receiving the speech recognition processing request data transmitted by the first speech recognition unit through the network, and for selecting a recognition target model from the database by sorting the channel data and speech data, and the recognition target of the terminal; a characteristic extraction unit for extracting speech recognition target characteristic components from the speech data sorted by the data reception unit; a channel estimation unit for estimating channel information of the recognition generating environment from the received speech data when the channel data are not included in the data received from the data reception unit; and a speech recognition unit for removing a noise component by adapting the noise component to the recognition target acoustic model stored in the database using the channel information estimated by the channel estimation unit or the channel estimation information received from the first speech recognition unit of the terminal, and for performing speech recognition.

Preferably, the speech recognition unit includes: a model adaptation unit for removing the noise component by adapting the channel component estimated by the channel estimation unit to the recognition target acoustic model stored in the database; a speech recognition unit for performing speech recognition for the inputted speech signal by decoding the speech data processed in the model adaptation unit; and a data transmission unit for transmitting the speech recognition processing results data to the speech recognition unit of the terminal through the network.

According to another aspect of the present invention, a speech recognition apparatus of a terminal for distributed speech recognition comprises: a speech detection unit for detecting a speech period from the inputted speech signal; a pause detection unit for detecting a pause period in the speech period detected by the speech detection unit, and for determining the kind of inputted speech signal; a channel estimation unit for estimating channel characteristics using data in a short pause period, except the detected speech period, in the speech detection unit; a characteristic extraction unit for extracting a recognition characteristic of the speech data when the pause period is not detected by the pause detection unit; a data processing unit for generating the speech recognition processing request data and for transmitting same to a speech recognition module of the server through a network when the pause period is detected in the pause detection unit; a model adaptation unit for removing the noise component by adapting the channel component estimated in the channel estimation unit to the recognition target acoustic model stored in the database; and a speech recognition unit for performing noise recognition of the speech signal inputted by decoding the speech data processed in the model adaptation unit.

According to yet another aspect of the present invention, a speech recognition apparatus of a server for a distributed speech recognition comprises: a data reception unit for receiving the speech recognition processing request data transmitted from a terminal through the network, and for selecting a recognition target model from the database by sorting the channel data and speech data, and the recognition target of the terminal; a characteristic extraction unit for extracting speech recognition target characteristic components from the speech data sorted by the data reception unit; a channel estimation unit for estimating channel information of the recognition generating environment from the received speech data when the channel data are not included in the data received from the data reception unit; a model adaptation unit for removing the noise component by adapting the channel component to the recognition target acoustic model stored in the database; a speech recognition unit for performing speech recognition with respect to the inputted speech signal by decoding the speech data processed by the model adaptation unit; and a data transmission unit for transmitting the speech recognition processing result data to the terminal through the network.

According to still yet another aspect of the present invention, a distributed speech recognition method in a terminal and a server comprises: determining the kind of inputted speech by checking a pause period of a speech period for speech signals inputted to the terminal, selecting a recognition target model of the speech stored, and then recognizing and processing the inputted speech data according to the selected recognition target model when the speech is processed in the system according to the kind of determined speech, and transmitting the speech recognition request data to the server through a network when the speech cannot be processed in the terminal; and selecting a recognition target model corresponding to the speech data to be recognized and processed by analyzing speech recognition request data transmitted from the terminal through the network in the server, performing a language process through speech recognition by applying the selected speech recognition target model, and transmitting the language processing result data to the terminal unit through the network.

Preferably, transmitting the speech recognition request data from the terminal to the server through the network includes: detecting the speech period from the inputted speech signal; determining the kind of inputted speech signal by detecting the pause period in the detected speech period; estimating the channel characteristic using data of non-speech period except the detected speech period; extracting the recognition characteristic of the speech data when the period is not detected; generating the speech recognition processing request data and transmitting the recognition characteristic and speech recognition processing request data to the server through the network when the pause period is detected; and performing speech recognition after removing the noise component by adapting the estimated channel component to the recognition target acoustic model stored in the database.

Preferably, performance of speech recognition includes: removing the noise component by adapting the estimated channel component to the recognition target acoustic model stored in the database; and performing speech recognition of the inputted speech signal by decoding the processed speech data.

Preferably, generation of the speech recognition processing request data and transmitting the data through the network to the server includes: constructing the speech recognition request data used to transmit the speech data to the server when the pause period is detected; and transmitting the constructed speech recognition processing request data through the network to the server.

Preferably, transmission of the speech recognition processing request data to the terminal includes: receiving the speech recognition processing request data transmitted by the terminal through the network, sorting the channel data, the speech data and the recognition target of the terminal, and selecting the recognition target model from the database; extracting the speech recognition target characteristic component from the sorted speech data; estimating channel information of the recognition environment from the received speech data when the channel data are not included in the received data; and performing speech recognition after adapting the estimated channel component or the channel estimation information received from the terminal to the recognition target acoustic model stored in the database and removing the noise component.

Preferably, performance of speech recognition includes: adapting the estimated channel component to the recognition target acoustic model stored in the database, and removing the noise component; performing speech recognition of the inputted speech signal by decoding the speech data from which the noise component is removed; and transmitting the speech recognition processing result data to the terminal through the network.

According to still yet another aspect of the present invention, a method for recognizing speech in a terminal for distributed speech recognition comprises: detecting the speech period from the inputted speech signal; determining the kind of inputted speech signal by detecting the pause period in the detected speech period; estimating the channel characteristic using data of a non-speech period except the detected speech period; extracting the recognition characteristic of the speech data when the period is not detected; generating the speech recognition processing request data, and transmitting the recognition characteristic and speech recognition processing request data through the network to the server when the pause period is detected; removing the noise component by adapting the estimated channel component to the recognition target acoustic model stored in the database; and performing speech recognition of the inputted speech signal by decoding the noise component removed speech data.

According to still yet another aspect of the present invention, a speech recognition method in a distributed recognition server comprises: transmitting the speech recognition processing request data to the terminal by receiving the speech recognition processing request data transmitted from the terminal through the network, sorting the channel data, the speech data, and the recognition target of the terminal, selecting the recognition target model from the database; extracting the speech recognition target characteristic component from the sorted speech data; estimating channel information of the recognition environment from the received speech data when the channel data are not included in the received data; removing the noise component by adapting the estimated channel component to the recognition target acoustic model stored in the database; performing speech recognition with respect to the inputted speech signal inputted by decoding the noise component removed speech data; and transmitting the speech recognition process result data to the terminal through the network.

According to still yet another aspect of the present invention, a speech recognition method in a distributed recognition server comprises: transmitting the speech recognition processing request data to the terminal by receiving the speech recognition processing request data transmitted by the terminal through the network, sorting the channel data, the speech data, and the recognition target of the terminal; selecting the recognition target model from the database; extracting the speech recognition target characteristic component from the sorted speech data; estimating channel information of the recognition environment from the received speech data when the channel data are not included in the received data; removing the noise component by adapting the estimated channel component to the recognition target acoustic model stored in the database; performing speech recognition with respect to the inputted speech signal by decoding the noise component removed speech data; and transmitting the speech recognition process result data to the terminal through the network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a speech recognition system within a wireless terminal in accordance with the present invention;

FIGS. 2A and 2B are graphs showing a method for detecting a speech period using a zero crossing rate and energy in a speech detection unit as shown in FIG. 1;

FIG. 3 is a block diagram of a speech recognition system in a server in accordance with the present invention;

FIG. 4 is an operation flowchart for a speech recognition method in a wireless terminal in accordance with the present invention;

FIG. 5 is an operation flowchart for a speech recognition method in a server in accordance with the present invention;

FIGS. 6A, 6B and 6C are views showing signal waveforms relating to detection of a speech pause period in the pause detection unit shown in FIG. 1; and

FIG. 7 is a view showing a data format scheme transmitted to a server in a terminal.

### DETAILED DESCRIPTION OF THE PREFERRED EMBODIMENTS

A distributed speech recognition system and a method thereof in accordance with the present invention will now be described more fully hereinafter with reference to the accompanying drawings.

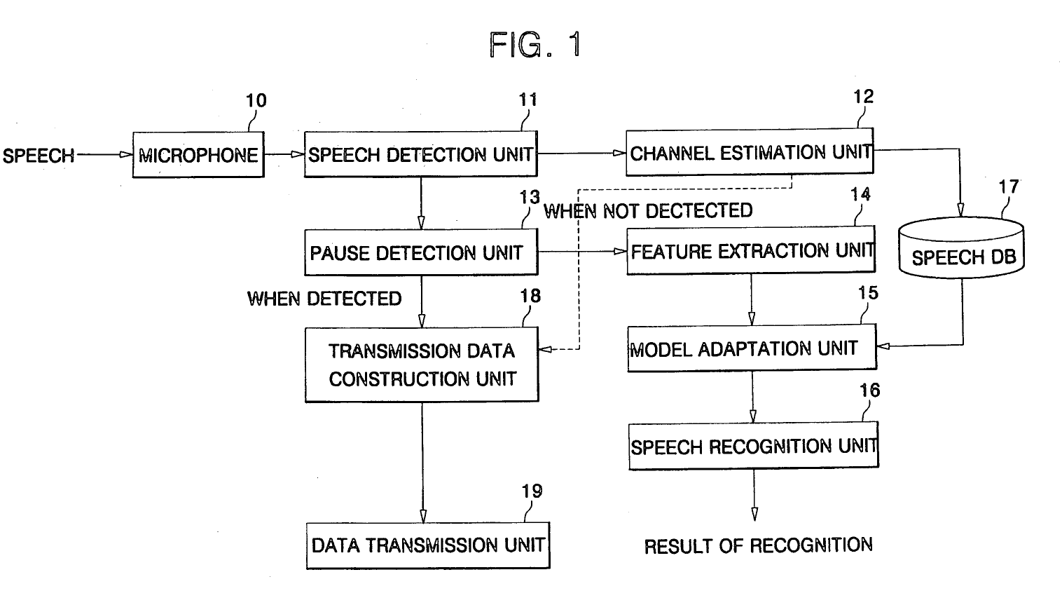

FIG. 1 is a block diagram of a speech recognition system within a wireless terminal in accordance with the present invention.

Referring to FIG. 1, the speech recognition system of a wireless terminal (client) includes a microphone 10, a speech detection unit 11, a channel estimation unit 12, a pause 11 detection unit 13, a feature extraction unit 14, a model adaptation unit 15, a speech recognition unit 16, a speech DB 17, a transmission data construction unit 18, and a data transmission unit 19.

The speech detection unit 11 detects a speech signal period from a digital speech signal inputted through the microphone 10 and provides it to the channel estimation unit 12 and the pause detection unit 13, which may extract the speech period from a corresponding input speech signal using the zero-crossing rate (ZCR) of a speech waveform, an energy of the signal, and so forth.

The pause detection unit 13 detects whether there is a pause period in the speech signal detected by the speech detection unit 1, which detects, in the time domain, a period that may be determined to be a short pause period within the speech period detected from the speech detection unit 11. A method of detecting the short pause period may be performed within the speech period detection method. That is, when exceeding a preset threshold value within the detected speech signal period using the ZCR and the energy, the short pause period is determined to exist in the speech period, and thus the detected speech signal is decided to be a phrase or sentence rather than a word, so that the recognition process may be performed in the server.

The channel estimation unit 12 estimates a channel environment with respect to the speech signal in order to compensate for an inharmonious recording environment between the speech signal detected by the speech detection unit 11 and the speech signal stored in the speech DB 17. Such an inharmonious environment of the speech signal, that is, the channel environment, is a main factor that reduces the speech recognition rate, which estimates a feature of the channel using data of the period having no speech in the previous and next periods within the detected speech period.

In the channel estimation unit 12, the feature of the channel may be estimated using frequency analysis, energy distribution, a non-speech period feature extraction method (e.g., a cepstrum), a waveform average in the time domain, and so forth.

The feature extraction unit 14 extracts a recognition feature of the speech data and provides it to the model adaptation unit 15 when the pause detection unit 13 does not detect the short pause period.

The model adaptation unit 15 adapts the short pause model to a situation of the current channel estimated in the channel estimation unit 12, which applies parameters of the estimated channel to feature parameters extracted through the adaptation algorithm. Channel adaptation uses a method for removing channel components reflected in the parameters that constitute extracted feature vectors, or a method for adding the channel component to the speech model stored in the speech DB 17.

The speech recognition unit 16 performs word recognition by decoding the feature vector extracted using the speech recognition engine existing in the terminal.

The transmission data construction unit 18 constructs data combining the speech data and channel information, or combines the extracted feature vector and the channel information, and then transmits them to the server through the data transmission unit 19 when the pause detection unit 13 detects the short pause period existing in the speech data, or when the inputted speech is longer than a specified length preset in advance.

Detailed operation of the speech recognition system of a wireless terminal in accordance with the present invention constructed described above will now be explained.

First, when the speech signal of a user is inputted through the microphone 10, the speech detection unit 11 detects a substantial speech period from the inputted speech signal.

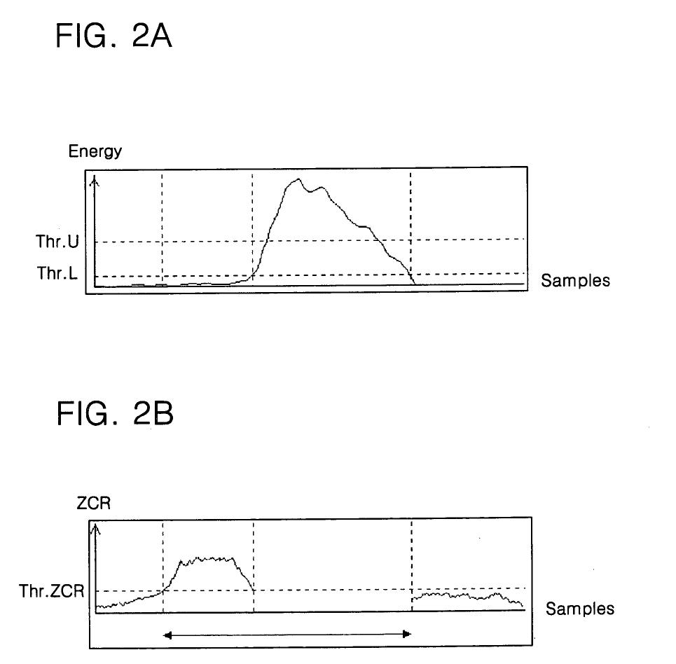

The speech detection unit 11 detects the speech period using the energy and ZCR of the speech signal as shown in FIGS. 2A and 2B. In the latter regard, the term “ECT” refers to the number of times that the adjacent speech signals are changed in algebraic sign, and it is a value including frequency information relating to the speech signal.

It can be seen from FIGS. 2A and 2B that a speech signal having a sufficiently high SNR (Signal-to-Noise Ratio) makes a clear distinction between the background noise and the speech signal.

The energy may be obtained by calculating a sample value of the speech signal, and the digital speech signal is analyzed by dividing the inputted speech signal in short-periods. When one period includes N speech samples, the energy may be calculated using one of the following Mathematical Expressions 1, 2 and 3.

$$\begin{matrix}Mathematical Expression 1 \text{:} \\ E = 10 {log}_{10} ( e + \frac{1}{N} {\sum }_{n = 1}^{N} {s ( n )}^{2} ) \text{:} log energy \\ Mathematical Expression 2 \text{:} \\ E = \frac{1}{N} {\sum }_{N - 1}^{N} {s ( n )}^{2} \text{:} average energy \\ Mathematical Expression 3 \text{:} \\ E = \sqrt{\frac{1}{N} {\sum }_{n - 1}^{N} {s ( n )}^{2}} \text{:} RMS energy\end{matrix}$$

Meanwhile, the ZCR is the number of times that the speech signal crosses a zero reference, which is considered to be a frequency, and which has a low value in an unvoiced sound and a high value in a voiced sound. That is, the ZCR may be expressed by the following Mathematical Expression 4.
ZCR++ if sign(s[n])×sign(s[n+1])<0 Mathematical Expression 4:

That is, if the product of the two adjacent speech signals is negative, the speech signal passes through the zero point once, thus increasing the value of the ZCR.

In order to detect the speech period in the speech detection unit 11 using the energy and the ZCR described above, the energy and the ZCR are calculated in a silent period having no speech, and then threshold values (Thr) of the energy and the ZCR are calculated.

A determination is made as to whether or not there is speech by comparing each of the energy and the ZCR value in the short-period with the calculated threshold value through the short-period analysis of the inputted speech signal. Here, the following conditions should be satisfied in order to detect a start portion of the speech signal.

Condition 1: Value of the energy in several to several tens of short-periods>Threshold value of the energy

Condition 2: Value of the ZCR in several to several tens of short-periods<Threshold value of the ZCR

When these two conditions are satisfied, it is determined that the speech signal exists from the beginning of the initial short-period that satisfies the conditions.

When the following two conditions are satisfied, the inputted speech signal is determined to be an end portion thereof.

Condition 3: Value of the energy in several to several tens of short-periods<Threshold value of the energy

Condition 4: Value of the ZCR in several to several tens of short-periods>Threshold value of the ZCR

To summerize the speech detection process of the speech detection unit 11 shown in FIG. 1, when the energy value exceeds the threshold value (Thr.U), it is determined that the speech is beginning, and thus, the beginning of the speech period is set ahead of a predetermined short-period from the corresponding time point. However, when the short-period in which the energy value falls below the threshold value (Thr.L) is maintained for a predetermined time, it is determined that the speech period is terminated. That is, the speech period is determined on the basis of the ZCR value concurrently with the energy value.

The ZCR indicates how many times a level of the speech signal crosses the zero point. The level of the speech signal is determined to cross the zero point when the product of the sample values of the two nearest speech signals: current speech signal and the just-previous speech signal is negative. The ZCR can be adopted as a standard for determination of the speech period because the speech signal always includes a periodic period in the corresponding period, and the ZCR of the periodic period is considerably small compared to that of the silent period having no speech. That is, as shown in FIGS. 2A and 2B, the ZCR of the silent period having no speech is higher than a specific threshold value (Thr.ZCR).

The channel estimation unit 12 shown in FIG. 1 estimates channels of the speech channel using a signal of the silent or non-speech period existing before and/or after the speech period detected in the speech detection unit 11.

For example, a feature of the current channel is estimated using the signal of the non-speech period, and it may be estimated by an average of properties of the short-periods being temporally continuous. In this regard, the input signal x(n) of the non-speech period may be expressed as the sum of a signal c(n) occurring due to channel distortion and an environment noise signal n(n). That is, the input signal of the non-speech period may be expressed by the following Mathematical Expression 5.
x(n)=c(n)+n(n)
X(e^{jw})=c(e^{jw})+N(e^{jw}) Mathematical Expression 5:

Upon estimating the channel using the foregoing method, components of the environment noise may be degraded due to the sum of a several number of continuous frames. The added noise of the environment may be removed from its component by an average of the sum. That is, the noise may be removed using the following Mathematical Expression 6.

$$\begin{matrix}Mathematical Expression 6 \text{:} \\ \hat{x} [ n ] = \frac{1}{l} {\sum }_{l} x [ n ] \\ = \frac{1}{l} {\sum }_{l} ( c [ n ] + n [ n ] ) \frac{1}{l} {\sum }_{l} n [ n ] \\ \approx 0 \\ \hat{X} ( {ⅇ}^{j w} ) = 𝔍 ( \hat{x} [ n ] ) \\ = 𝔍 ( \frac{1}{l} {\sum }_{l} ( c [ n ] + n [ n ] ) \\ = 𝔍 ( \frac{1}{l} {\sum }_{l} c [ n ] + \frac{1}{l} {\sum }_{l} n [ n ] ) \\ = 𝔍 ( \hat{c} [ n ] ) \\ = \hat{C} ( {ⅇ}^{j w} )\end{matrix}$$

Although an exemplary algorithm for channel estimation has been suggested hereinabove, it should be understood that any algorithm, other than the exemplary algorithm, for the channel estimation may be applied.

The channel component estimated through the above-mentioned algorithm is used for adaptation to a channel of the acoustic model stored in the speech DB 17 of the mobile terminal serving as a client.

Short pause period detection in the pause detection unit 13 shown in FIG. 1 may be performed using the ZCR and the energy in the same way as speech period detection is performed in the speech detection unit 11. However, the threshold value used for short pause period detection may be different from that used for speech period detection. This is aimed at reducing an error that may detect the unvoiced sound period (that is, the noise period expressed as a random noise) as the short pause period.

When the short non-speech period appears constantly after determination of the start of the speech period but before determination of the end of the speech period, the inputted speech signal is determined to be natural language data that are processed not in the speech recognition system of the terminal but in the server so that the speech data are transmitted to the transmission data construction unit 18. The transmission data construction unit 18 will be described below.

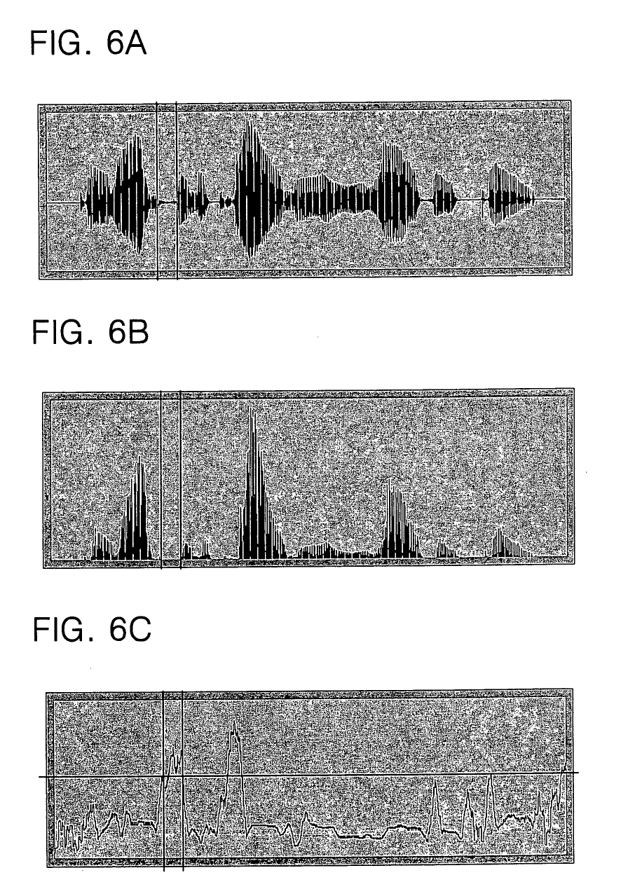

The short pause period is detected using the ZCR and the energy in the same manner as the speech period detection, which is shown in FIGS. 6A-6C. That is, FIG. 6A shows a speech signal waveform, FIG. 6B shows a speech signal waveform calculated by use of energy, and FIG. 6V shows a speech signal waveform calculated by use of a ZCR.

As shown in FIGS. 6A-6C, the period that has small energy, and the ZCR exceeding a predetermined value between the start and end of the speech period, may be detected as the short pause period.

Speech data from which the short pause period is detected makes up the transmission data in the transmission data construction unit 18, which transmits them to the server through the data transmission unit 19, in order to perform speech recognition no longer in the client (that is, the wireless terminal) but in the server. At this point, the data to be transmitted to the server may include an identifier capable of identifying the kind of terminal (that is, a vocabulary which the terminal intends to recognize), speech data and estimated channel information.

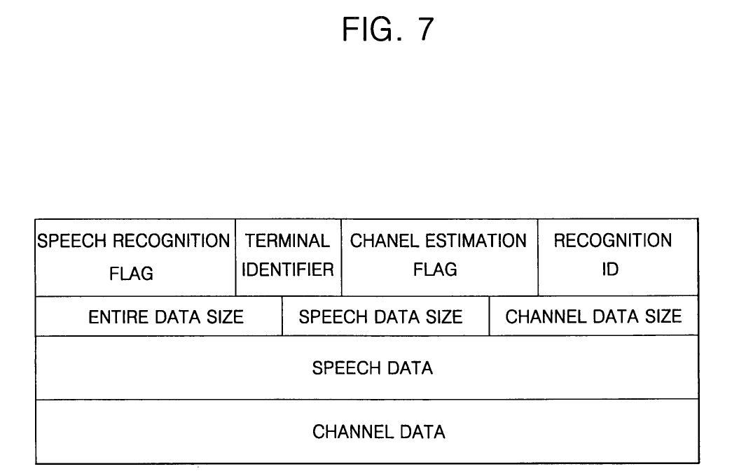

Meanwhile, speech detection and short pause period detection may be performed together for a calculation quantity and a rapid recognition speed of the wireless terminal. When a period determined to be the non-speech period exists to a predetermined extent and then the speech period appears again, the speech signal is determined to be a target for natural language recognition, so that the speech data are stored in a buffer (not shown) and are transmitted to the server through the terminal data transmission unit 19. At this point, it is possible to include only the types of recognition target unique to the terminal and the speech data in the data to be transmitted, and to perform channel estimation in the server. Data to be transmitted to the server from the data transmission unit 19, that is, a data format constructed in the transmission data construction unit 18, is shown in FIG. 7.

As shown in FIG. 7, the data format constructed in the transmission data construction unit 18 includes at least one of the following: speech recognition flag information for determining whether or not data to be transmitted to the server are data for recognizing speech; a terminal identifier for indicating a terminal for transmission; channel estimation flag information for indicating whether channel estimation information is included; recognition ID information for indicating a result of the recognition; size information for indicating a size of the entire data to be transmitted; size information relating to speech data; and size information relating to channel data.

On the other hand, for the purposes of speech recognition, feature extraction is performed on a speech signal in which the short pause period is not detected in the short pause detection unit 13. In the latter regard, feature extraction is performed by using the frequency analysis used in the channel estimation process. Hereinafter, feature extraction will be explained in more detail.

Generally, feature extraction is a process for extracting a component useful for speech recognition from the speech signal. Feature extraction is related to compression and dimension reduction of information. Since there is no ideal solution in feature extraction, the speech recognition rate is used to determine whether or not the feature of the speech recognition is good. The main research field of feature extraction is an expression of a feature reflecting a human auditory feature, and an extraction of a feature strong to various noise environment/speaker/channel changes and an extraction of a feature expressing a change of time.

The generally used feature extraction process reflecting the auditory feature includes a filter bank analysis applying the cochlea frequency response, a center frequency allocation of the mel or Bark dimension unit, an increase of bandwidth according to the frequency, a pre-emphasis filter, and so forth. A most widely used method for enhancing robustness is CMS (Cepstral Mean Subtraction), which is used to reduce the influence of a convolutive channel. The first and second differential values are used in order to reflect a dynamic feature of the speech signal. The CMS and differentiation are considered as filtering in the direction of the time axis, and involve a process for obtaining a temporally uncorrelated feature vector in the direction of the time axis. A process for obtaining a cepstrum from the filter bank coefficient is considered an orthogonal transform used to change the filter bank coefficient to an uncorrelated one. The early speech recognition which has used the cepstrum employing LPC (Linear Predictive Coding) has used a liftering that applies weights to the LPC cepstrum coefficient.

The feature extraction method that is mainly used for speech recognition includes an LPC cepstrum, a PLP cepstrum, an MFCC (Mel Frequency Cepstral Coefficient), a filter bank energy, and so on.

Herein, a method of finding the MFCC will be briefly explained.

The speech signal passes through an anti-aliasing filter, undergoes analog-to-digital (A/D) conversion, and is converted into a digital signal x(n). The digital speech signal passes through a digital pre-emphasis filter having a high band-pass characteristic. There are various reasons why the digital emphasis filter is used. First, a high frequency band is filtered to model frequency characteristics of the human outer ear/middle ear. Thereby, the digital emphasis filter compensates for attenuation to 20 db/decade occurring due to an emission from the lib, thus obtaining only a vocal tract characteristic from the speech. Second, the digital emphasis filter somewhat compensates for the fact that the auditory system is sensitive to the spectrum domain over 1 KHz. An equal-loudness curve, which is a frequency characteristic of the human auditory organ, is directly modeled for extraction of the PLP feature. A pre-emphasis filter characteristic H(z) is expressed by the following Mathematical Expression 7.
H(z)=1−az⁻¹ Mathematical Expression 7:
where the symbol a has a value ranging from 0.05 to 0.98.

The signal passed through the pre-emphasis filter is encapsulated in a hamming window and divided into frames in a unit of block. The following processes are all performed in a unit of frame. The size of the frame is commonly 20-30 ms and a shift of the frame is generally performed in 10 ms. The speech signal of one frame is converted into the frequency domain using the FFT (Fast Fourier Transform). The frequency domain may be divided into several filter banks, and then the energy of each bank may be obtained.

After taking the logarithm of the band energy obtained in such a manner, the final MFCC may be obtained by performing a DCT (Discrete Cosine Transform).

Although a method for extracting the feature using the MFCC is mentioned in the above description, it should be understood that the feature extraction may be performed using a PLP cepstrum, filter band energy and so forth.

The model adaptation unit 15 performs model adaptation using a feature vector extracted from the feature extraction unit 14 and an acoustic model stored in the speech DB 17 shown in FIG. 1.

Model adaptation is performed to reflect distortion occurring due to the speech channel being inputted currently to the speech DB 17 held by the terminal. Assuming that the input signal of the speech period is y(n), the input signal may be expressed as the sum of a speech signal s(n), a channel component c(n), and a noise component n(n) as shown in the following Mathematical Expression 8.
y(n)=s(n)+c(n)+n(n)
Y=S(e^{jw})=C(e^{jw})+N(e^{jw}) Mathematical Expression 8:

It is assumed that the noise component is reduced to a minimum by noise removal logic commercialized currently, and the input signal is considered to be the sum of the speech signal and the channel component. That is, the extracted feature vector is considered to include both the speech signal and the channel component, and reflects a lack of environment harmony with respect to the model stored in the speech DB 17 in the wireless terminal. That is, an input signal from which the noise is removed is expressed by the following Mathematical Expression 9.
Y=S(e^{jw})=S(e^{jw})+C(e^{jw}):noise removed input signal Mathematical Expression 9:

Inharmonious components of all channels may be minimized by adding an estimated component to the model stored in the speech DB 17 in the wireless terminal. In addition, the input signal in the feature vector space may be expressed by the following Mathematical Expression 10.
Y(v)=S(v)+C(n)+S⊕C(v) Mathematical Expression 9:

Here, S⊕C(v) is a component derived from the sum of the speech and channel component.

At this point, since the channel component having a stationary feature and the speech signal are irrelevant to each other, the feature vector appears as a very small component in the feature vector space.

Assuming that the feature vector stored in the speech DB 17 using such relationship is R(v), the model adaptation performs an addition of a channel component C′(v) estimated in the channel estimation unit, and then generates a new model feature vector R″(v). That is, a new model feature vector is calculated by the following Mathematical Expression 11.
R′(v)=R(v)+C′(v) Mathematical Expression 11:

Accordingly, the speech recognition unit 16 shown in FIG. 1 performs speech recognition using the model adapted through the above described method in the model adaptation unit 15 and obtains the speech recognition result.

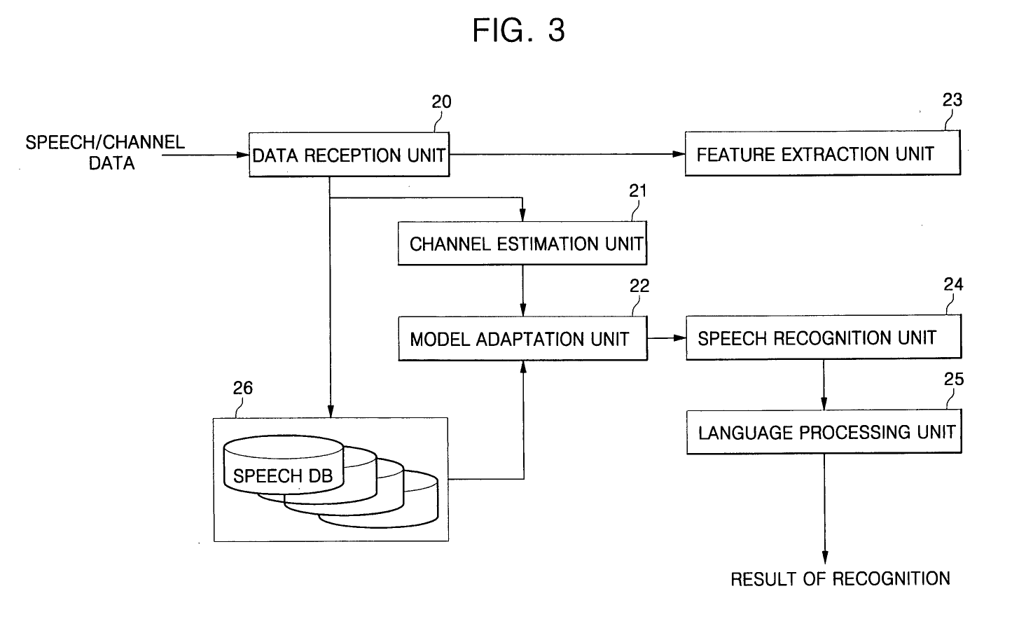

The construction and operation of the server to process natural language where the speech recognition process was not processed in the terminal as described above (that is, construction and operation of the server which processes the speech data for the speech recognition transmitted from the terminal) will be described with reference to FIG. 3.

FIG. 3 is a block diagram of a speech recognition system of a network server.

Referring to FIG. 3, the speech recognition system of the network server includes a data reception unit 20, a channel estimation unit 21, a model adaptation unit 22, a feature extraction unit 23, a speech recognition unit 24, a language processing unit 25, and a speech DB 26.

The data reception unit 20 receives data to be transmitted from the terminal in a data format shown in FIG. 7, and parses each field of the received data format.

The data reception unit 20 extracts a model intended for recognition from the speech DB 26 using an identifier value of the terminal stored in an identifier field of the terminal in the data format shown in FIG. 7.

The data reception unit 20 checks the channel data flag in the received data and determines whether the channel information, together with the data, is transmitted from the terminal.

As a result of the latter determination, if the channel information, together with the data, was transmitted from the terminal, the data reception unit 20 provides the model adaptation unit 22 with the channel information and adapts the information to the model extracted from the speech DB 26. In this regard, the method for adapting the model in the model adaptation unit 22 is performed in the same manner as in the model adaptation unit 15 in the terminal shown in FIG. 1.

On the other hand, if the channel information, together with the received data, was not transmitted from the terminal, the data reception unit 20 provides the channel estimation unit 21 with the received speech data.

Accordingly, the channel estimation unit 21 directly performs channel estimation using the speech data provided by the data reception unit 20. In this respect, the channel estimation unit 21 performs the channel estimation operation in the same manner as in the channel estimation unit 12 shown in FIG. 1.

Accordingly, the model adaptation unit 22 adapts the channel information estimated in the channel estimation unit 21 to the speech model estimated from the speech DB 26.

The feature extraction unit 23 extracts a feature of the speech signal from the speech data received from the data reception unit 20, and provides the speech recognition unit 24 with extracted feature information. The feature extraction operation is also performed in the same manner as in the feature extraction unit 14 of the terminal shown in FIG. 1.

The speech recognition unit 24 performs the recognition of the feature extracted in the feature extraction unit 23 using the model adapted in the model adaptation unit 22, and provides the language process unit 25 with the recognition result so that it performs the natural language recognition from the language process unit 25. Since the language to be processed is not words but characters, that is, data corresponding to the level of at least a phrase, a natural language management model to precisely discriminate the characters is applied in the language process unit 25.

The language process unit 25 terminates the speech recognition process by transmitting the natural language speech recognition process results data processed in the language process unit 25, including a data transmission unit (not shown), together with the speech recognition ID, to the terminal which is the client through the data transmission unit.

On summarizing the speech recognition operation in the network server, available resources of the speech recognition system on the server side are massive compared to those of the terminal of client. This is due to the fact that the terminal performs speech recognition at the word level and the server side has to recognize the natural language, that is, the characters, the speech data corresponding to at least the phrase level.

Accordingly, the feature extraction unit 23, the model adaptation unit 22 and the speech recognition unit 24 shown in FIG. 3 use more accurate and complicated algorithms compared to the feature extraction unit 14, the model adaptation unit 15 and the speech recognition unit 16 of the terminal which is the client.

The data reception unit 20 shown in FIG. 3 divides data transmitted from the terminal which is the client into the recognition target kinds of the terminal, the speech data, and the channel data.

When the channel estimation data are not received from the terminal, the channel estimation unit 21 in the speech recognition system of the server side estimates the channel using the received speech data.

The model adaptation unit 22 will require more precise model adaptations in the estimated channel feature since various pattern matching algorithms are added to the model adaptation unit 22, and the feature extraction unit 23 also plays a role that could not be performed using the resources of the terminal which is the client. For example, it should be noted that a pitch synchronization feature vector may be constructed by a precise pitch detection (at this time, the speech DB also is constructed with the same feature vector), and various trials to enhance the recognition performance may be applied.

A distributed speech recognition method in the terminal and server in accordance with the present invention corresponding to the distributed speech recognition system in the terminal (client) and network server in accordance with the present invention described above will be explained step by step with reference to the accompanying drawings.

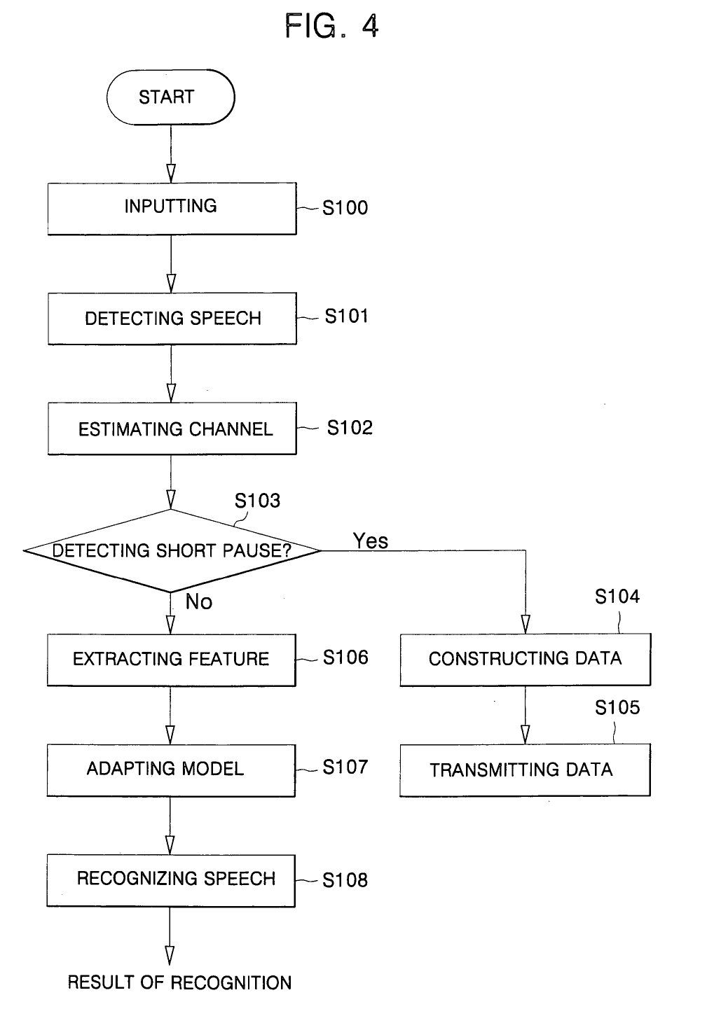

First, a speech (a word) recognition method in a terminal which is the client will be explained with reference to FIG. 4.

Referring to FIG. 4, when a user speech signal is inputted from the microphone (S100), a speech period is detected from the inputted speech signal (S101). The speech period may be detected by calculating the ZCR and the energy of the signal as shown in FIGS. 2A and 2B. That is, as shown in FIG. 2A, when the energy value is higher than a preset threshold value, it is determined that the speech was started so that the speech period is determined to start before a predetermined period from the corresponding time. If a period whose energy value is below the preset threshold value continues for a predetermined time, it is determined that the speech period has terminated.

Meanwhile, passage through the zero point for the ZCR, is determined when a product of a sample value of the current speech signal and a sample value of the just-previous speech signal is negative. The ZCR can be adopted as a standard for determination of the speech period because the inputted speech signal always includes a periodic period in the corresponding period, and the ZCR of the periodic period is considerably small compared to the ZCR of the period having no speech. Accordingly, as shown in FIG. 2B, the ZCR in the period having no speech appears to be higher than the preset ZCR threshold, and conversely does not appear in the speech period.

When the speech period of the input speech signal is detected using such method, the channel of the speech signal is estimated using the signal of the non-speech period existing in the time period prior to and after the detected speech period (S102). That is, a feature of the current channel is estimated through a frequency analysis using the signal data of the non-speech period, where the estimation may be made as an average of the short-period which continues in the time domain. In this regard, the input signal of the non-speech period may be expressed by Mathematical Expression 5. The above estimated channel feature is used to make an adaptation to the channel of the acoustic model stored in the speech DB 17 in the terminal.

After channel estimation is performed, it is determined whether the pause period exists in the inputted speech signal by detecting the pause period from the speech signal inputted using the ZCR and the energy (S103).

The pause period may be detected using the ZCR and the energy as in step S101, wherein the threshold value used at this time may be different from the value used to detect the speech period. This is done to reduce the error when the unvoiced sound period (that is, a noise period that may be expressed as an arbitrary noise) is detected as the pause period.

When the non-speech period of a predetermined short period appears before the end of the speech period is determined since the speech period is determined to begin, the inputted speech signal is determined to be natural language data that is not processed in the speech recognition system of the terminal, so that the speech data are transmitted to the server. As a result, the period which has small energy and a ZCR higher than a predetermined value between the start and end of the speech period may be detected as the short pause period.

That is, as a result of detecting the short pause period in step S1103, when the short pause period is detected in the speech period, the speech signal inputted by the user is determined to be natural language that does not process the speech recognition in the speech recognition system of the terminal which is the client, and data to be transmitted to the server are constructed (S104). Then, the constructed data are transmitted to the speech recognition system of the server through the network (S105). In this regard, the data to be transmitted to the server have the data format shown in FIG. 7. That is, the data to be transmitted to the server may include at least one of a speech recognition flag used to identify whether the data to be transmitted is data for speech recognition, a terminal identifier for indicating an identifier of a terminal for transmission, a channel estimation flag for indicating whether the channel estimation information is included in the data, a recognition identifier for indicating the result of recognition, size information for indicating the size of the entire data to be transmitted, size information of speech data, and size information of channel data.

Meanwhile, as a result of the short pause period detection in step S103, when it is determined that the short pause period does not exist in the speech period (that is, with respect to the speech signal whose short pause period is not detected), feature extraction for word speech recognition is performed (S106). In this regard, the feature extraction for the speech signal whose BRL period is not detected may be performed using a method using frequency analysis which is used in estimating the channel, the representative method of which may be a method where an MFCC is used. The method for using the MFCC is not described here since it has been described in detail above.

After extracting the feature component for the speech signal, the acoustic model stored in the speech DB within the terminal is adapted using the extracted feature component vector. That is, model adaptation is performed in order to reflect distortion caused by the channel of the speech signal currently inputted to the acoustic model stored in the speech DB in the terminal (S107). That is, model adaptation is performed to adapt the short pause model to a situation of an estimated current channel, which applies the parameter of the estimated channel to the feature parameter extracted through the adaptation algorithm. Channel adaptation uses a method for removing the channel component which is reflected in the parameter constructing the extracted feature vector, or a method for adding the channel component to the speech model stored in the speech DB.

Speech recognition is performed by decoding words for the speech signal inputted by decoding the feature vector obtained through the model adaptation of step S107 (S108).

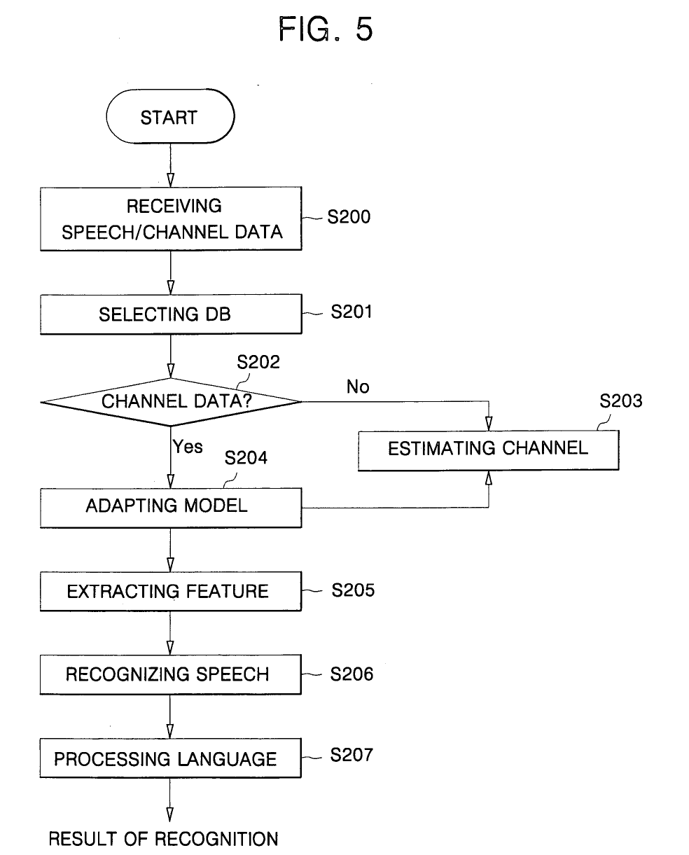

Hereinafter, a method for performing speech recognition after receiving the speech data (natural language: a sentence, a phrase, etc.), which is not processed in the terminal which is the client but which is transmitted, will be explained step by step with reference to FIG. 5.

FIG. 5 is an operation flowchart for a speech recognition method in the speech recognition system within a network server.

First, as shown in FIG. 5, data to be transmitted in the data format shown in FIG. 7 from a terminal which is a client is received, and each field of the received data format is parsed (S200).

The data reception unit 20 selects a model intended for recognition from the speech DB 26 using an identifier value of the terminal stored in an identifier field of the terminal in a data format shown in FIG. 7 (S201).

Then, it is identified whether there is a channel data flag in the received data, and it is determined whether channel data, together with the received data, are transmitted from the terminal (S202).

As a result of the latter determination, when channel information is not transmitted from the terminal, the data reception unit 20 estimates the channel of the received speech data. That is, data transmitted from the terminal which is the client is classified into the kind of recognition target of the terminal, the speech data, and the channel data, and when the channel estimation data are not received from the terminal, the data reception unit estimates the channel using the received speech data (S203).

Meanwhile, as a result of the determination made in step S202, when the channel data are received from the terminal, the channel data are adapted to a model selected from the speech DB, or are adapted to a speech model selected from the speech DB using the channel information estimated in step S203 (S204).

After adapting the channel data to the model, a feature vector component for speech recognition is extracted from the speech data according to the adapted model (S205).

The extracted feature vector component is recognized, and the recognized result is subjected to language processing by use of the adapted model (S206, S207). In this regard, since the language to be processed is not words but characters, the data corresponding to the level of at least a phrase, a natural language management model for precise discrimination of the language is applied to the language processing operation.

The speech recognition process is terminated by transmitting the resultant speech recognition processing data of the natural language, which is subjected to language processing in this manner, together with the speech recognition ID, to the terminal which is the client through the network.

As can be seen from the foregoing, the distributed speech recognition system and method according to the present invention makes it possible to recognize a word and a natural language using detection of the short pause period within a speech period in the inputted input signal. In addition, the present invention makes it possible to recognize various groups of recognition vocabulary (for example, a home speech recognition vocabulary, a telematics vocabulary for a vehicle, a vocabulary for call center, etc.) to be processed in the same speech recognition system by selecting the recognition vocabulary required by the corresponding terminal using the identifier of the terminal since various terminals require various speech recognition targets.

The influence of various types of channel distortion caused by the type of terminal and the recognition environment is minimized by adapting them to the speech database model using the channel estimation method so that speech recognition performance can be improved.

Although preferred embodiments of the present invention have been described, it will be understood by those skilled in the art that the present invention should not be limited to the described preferred embodiments. Rather, various changes and modifications may be made within the spirit and scope of the present invention, as defined by the following claims.

What is claimed is:

1. A distributed speech recognition system, comprising:
a first speech recognition unit for checking a pause period of a speech period in an inputted speech signal to determine a type of an inputted speech, for selecting a recognition target model of a stored speech on the basis of the type of the inputted speech when the inputted speech can be recognized by itself to thus recognize data of the inputted speech on the basis of the selected recognition target model, and for transmitting speech recognition request data through a network when the inputted speech cannot be recognized by itself; and
a second speech recognition unit for analyzing the speech recognition request data transmitted by the first speech recognition unit through the network to select the recognition target model corresponding to the speech to be recognized, for applying the selected speech recognition target model to perform language processing through speech recognition, and for transmitting resultant language processing data to the first speech recognition unit through the network.

2. The system according to claim 1, wherein the first speech recognition unit is mounted on the terminal, and the second speech recognition unit is mounted on a network server so that the speech recognition is performed in a distributed manner.

3. The system according to claim 2, wherein the terminal is at least one of a telemetics terminal, a mobile terminal, a wireless local area network (WALN) terminal, and an IP terminal.

4. The system according to claim 1, wherein the first speech recognition unit comprises:
a speech detection unit for detecting a speech period from the inputted speech signal;
a pause detection unit for detecting a pause period in the speech period detected by the speech detection unit to determine the type of the inputted speech signal;
a channel estimation unit for estimating channel characteristics using data of a non-speech period other than the speech period detected by the speech detection unit;
a feature extraction unit for extracting a recognition feature of the speech data when the pause period is not detected by the pause detection unit;
a data processing unit for generating the speech recognition request data, and for transmitting the speech recognition request data to the second speech recognition unit when the pause period is detected by the pause detection unit; and
a speech recognition unit for removing a noise component by adapting a channel component estimated by the channel estimation unit to a recognition target acoustic model stored in a database, and for performing noise recognition.

5. The system according to claim 4, wherein the speech detection unit detects the speech period according to a result of comparing a zero-crossing rate and energy of a speech waveform for the inputted speech signal and a preset threshold value.

6. The system according to claim 4, wherein the speech recognition unit comprises:
a model adaptation unit for removing the noise component by adapting the channel component estimated in the channel estimation unit to the recognition target acoustic model stored in the database; and
a speech recognition unit for decoding speech data processed in the model adaptation unit, and for performing speech recognition with respect to the inputted speech signal.

7. The system according to claim 4, wherein the pause detection unit determines inputted speech data to be speech data for words when the pause period does not exist in the speech period detected by the speech detection unit, and determines the inputted speech data to be speech data for natural language when the pause period exists in the speech period.

8. The system according to claim 4, wherein the channel estimation unit uses, as a calculating method, at least one of a frequency analysis of continuous short periods, an energy distribution, a cepstrum, and a wave waveform average in a time domain.

9. The system according to claim 4, wherein the data processing unit comprises:
a transmission data construction unit for constructing the speech recognition processing request data used to transmit the pause period to the second speech recognition unit when the pause period is detected by the pause detection unit; and
a data transmission unit for transmitting the constructed speech recognition processing request data to the second speech recognition system through the network.

10. The system according to claim 9, wherein the speech recognition request data includes at least one of a speech recognition flag, a terminal identifier, a channel estimation flag, a recognition identifier, an entire data size, a speech data size, a channel data size, speech data, and channel data.

11. The system according to claim 1, wherein the second speech recognition unit comprises:
a data reception unit for receiving the speech recognition request data transmitted by the first speech recognition unit through the network, and for selecting the recognition target model from the database by sorting channel data and speech data, and a recognition target of the terminal;
a characteristic extraction unit for extracting speech recognition target characteristic components from the speech data sorted by the data reception unit;
a channel estimation unit for estimating channel information of the recognition generating an environment from the received speech data when the channel data are not included in the data received from the data reception unit; and
a speech recognition unit for removing a noise component by adapting the noise component to a recognition target acoustic model stored in a database using one of a channel component estimated by the channel estimation unit and channel estimation information received from the first speech recognition unit, and for performing speech recognition.

12. The system according to claim 11, wherein the speech recognition unit comprises:
a model adaptation unit for removing the noise component by adapting the channel component estimated by the channel estimation unit to the recognition target acoustic model stored in the database;
a speech recognition unit for performing the speech recognition of the inputted speech signal by decoding speech data processed in the model adaptation unit; and
a data transmission unit for transmitting speech recognition processing result data to the speech recognition unit through the network.

13. The system according to claim 11, wherein the channel information estimation by the channel estimation unit uses, as a calculating method, at least one of a frequency analysis of continuous short periods, an energy distribution, a cepstrum, and a wave waveform average in a time domain.

14. A distributed speech recognition method in a terminal and a server, comprising the steps of:
determining a type of inputted speech by checking a pause period of a speech period for speech signals inputted to the terminal, selecting a recognition target model of stored speech, and recognizing and processing inputted speech data according to the selected recognition target model when the speech is able to be processed according to the determined type of the speech, and transmitting the speech recognition request data to the server through a network when the speech is not able to be processed in the terminal; and
selecting a recognition target model corresponding to speech data to be recognized and processed in the server by analyzing speech recognition request data transmitted by the terminal through the network, performing a language process through speech recognition by applying the selected recognition target model, and transmitting language processing result data to the terminal unit through the network.

15. The method according to claim 14, wherein transmitting the speech recognition request data to the server through the network comprises:
detecting a speech period from the inputted speech signal;
determining the type of the inputted speech by detecting the pause period in the detected speech period;
estimating a channel characteristic using data of a non-speech period excluding the detected speech period;
extracting a recognition characteristic of the speech data when the speech period is not detected;
generating the speech recognition request data when the pause period is detected, and transmitting the recognition characteristic and the speech recognition request data to the server through the network; and
performing speech recognition after removing a noise component by adapting an estimated channel component to a recognition target acoustic model stored in a database.

16. The method according to claim 15, wherein the speech period is detected as a result of comparing a zero-crossing rate and energy of the speech waveform for the inputted speech signal and a preset threshold value in the step of detecting the speech period.

17. The method according to claim 15, wherein the step of performing the speech recognition comprises:
removing the noise component by adapting the estimated channel component to the recognition target acoustic model stored in the database; and
performing the speech recognition of the inputted speech signal by decoding processed speech data.

18. The method according to claim 15, wherein detecting the pause period comprises determining inputted speech data to be speech data for words when the pause period does not exist in the detected speech period, and determining the inputted speech data to be speech data for natural language when the pause period exists in the speech period.

19. The method according to claim 15, wherein the step of estimating the channel characteristic uses, as a calculating method, at least one of a frequency analysis of continuous short periods, an energy distribution, a cepstrum, and a wave waveform average in a time domain.

20. The method according to claim 15, wherein the step of generating the speech recognition request data and transmitting the recognition characteristic and the speech recognition request data to the server through the network comprises:
constructing the speech recognition request data used to transmit the speech data to the server when the pause period is detected; and
transmitting the constructed speech recognition request data to the server through the network.

21. The method according to claim 20, wherein the speech recognition request data includes at least one of a speech recognition flag, a terminal identifier, a channel estimation flag, a recognition identifier, an entire data size, a speech data size, a channel data size, speech data, and channel data.

22. The method according to claim 14, wherein transmitting the speech recognition request data to the terminal comprises:
receiving the speech recognition request data transmitted by the terminal through the network, sorting channel data and speech data, and a recognition target of the terminal, and selecting the recognition target model from a database;
extracting a speech recognition target characteristic component from the sorted speech data;
estimating channel information of a recognition environment from received speech data when the channel data are not included in the received speech data; and
performing speech recognition after adapting one of an estimated channel component and the estimated channel information to the recognition target model stored in the database and removing the noise component.
